(19) United States
(12) Patent Application Publication
(10) Pub. No.: US 2020/0048554 A1
(43) Pub. Date: Feb. 13, 2020

(54) LIQUID CRYSTAL COMPOSITION WITH HIGH REFRACTIVE INDEX AND DISPLAY DEVICE THEREOF

(71) Applicant: Jiangsu Hecheng Display Technology Co., Ltd., Yangzhong (CN)

(72) Inventors: Di He, Yangzhong (CN); Wenming Han, Yangzhong (CN); Wenquan Ding, Yangzhong (CN); Haibin Xu, Yangzhong (CN); Heming Zhang, Yangzhong (CN); Junqiang Zhang, Yangzhong (CN); Yafei Yang, Yangzhong (CN); Yunyun Liu, Yangzhong (CN); Li Wang, Yangzhong (CN); Liwei Wang, Yangzhong (CN)

(73) Assignee: Jiangsu Hecheng Display Technology Co., Ltd., Yangzhong (CN)

(21) Appl. No.: 16/344,847

(22) PCT Filed: Oct. 27, 2017
(86) PCT No.: PCT/CN2017/108007

§ 371 Date: Apr. 25, 2019

(30) Foreign Application Priority Data
Nov. 16, 2016 (CN) 201611030728.4

(51) Int. Cl. C09K 19/44; C09K 19/52; C09K 19/30; C09K 19/32; C09K 19/34; C09K 19/20; C09K 19/12

(52) U.S. Cl. CPC C09K 19/44; C09K 19/52; C09K 19/3003; C09K 19/32; C09K 19/3405; C09K 2019/123; C09K 19/12; C09K 2019/3021; C09K 2019/3025; C09K 2019/3004; C09K 19/20

(57) ABSTRACT

The present invention provides a liquid crystal composition, comprising, 14-30% of one or more compounds of general Formula I, 8-30% of one or more compounds of general Formula II, 13-58% of one or more compounds of general Formula III, and 20-65% of one or more compounds of general Formula IV, on the basis of the total weight of the liquid crystal composition. The liquid crystal composition of the present invention has a higher retardation, a higher transmittance, a larger optical anisotropy, a proper clearing point, a lower rotational viscosity and a good low-temperature storage stability, and is applicable to liquid crystal display devices to meet the rapid response required by a liquid crystal display, and ensure good display of the liquid crystal display in a harsh environment.

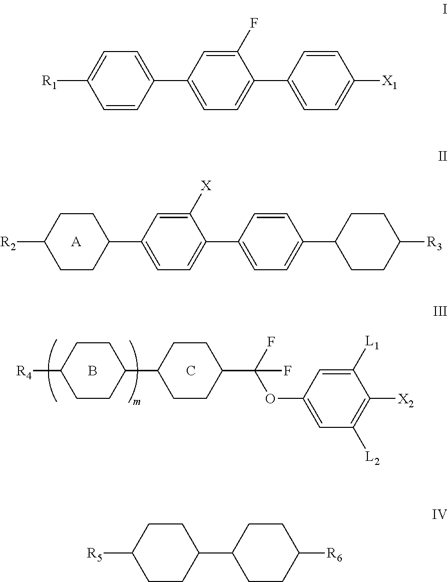

### TECHNICAL FIELD

The present invention relates to a liquid crystal composition, particularly to a liquid crystal composition having a higher retardation amount, a higher transmittance, a larger optical anisotropy, a proper clearing point, a lower rotational viscosity, a good low-temperature storage stability, and a rapid response. The present invention also relates to a liquid crystal display device comprising the same.

### BACKGROUND ARTS

The liquid crystal display device operates by utilizing the optical anisotropy and dielectric anisotropy of the liquid crystal material itself, and has been widely used at present. Based on the different characteristics and working modes of the liquid crystal materials, the device can be designed into various working modes, wherein the conventional display devices generally use a TN mode (i.e., twisted nematic mode—the liquid crystal compound has a nematic structure twisted by about 90 degrees), STN mode (i.e., super-twisted nematic mode), SBE mode (i.e., super-twisted birefringence mode), ECB mode (i.e., electronically controlled birefringence mode), VA mode (i.e., vertical alignment mode), IPS mode (i.e., in-plane switching mode), etc. There are many improved modes based on the above various modes. Devices operating in TN, STN, and SBE modes generally use positive dielectric anisotropic liquid crystals, devices operating in ECB and VA modes use negative dielectric anisotropic liquid crystals, and the IPS mode can use both positive and negative dielectric anisotropic liquid crystals.

Generally, the passive driving is used in the low information volume. As the information volume increases, the display size and the number of display channels increase, and crosstalk and contrast reduction become severe, an active matrix (AM) driving method is thus generally employed. Currently, thin film transistors (TFTs) are more used for driving. In the AM-TFT element, the TFT switching device is addressed in a two-dimensional grid, and charges the pixel electrode for a limited time during conduction, and then turns off again until it is addressed in the next cycle. Therefore, between two address cycles, the change of voltage at the pixel is undesired; otherwise the transmittance of the pixel will change, resulting in instability of the display. The discharge rate of a pixel depends on the electrode capacity and the resistivity of the dielectric material between the electrodes. Therefore, the liquid crystal material is required to have a higher resistivity, a suitable optical birefringence value Δn (generally, the Δn value is around 0.08-0.10), and a lower threshold voltage to achieve reductions in driving voltage and power consumption. The liquid crystal material is also required to have a lower viscosity to meet the requirement of rapid response. Such liquid crystal compositions have been reported in many literatures, for example, WO9202597, WO9116398, WO9302153, WO9116399, CN1157005A and the like.

With the developments of liquid crystal display technology and new display modes, there are constantly new requirements for the parameters of liquid crystal compositions. On one hand, the liquid crystal display device is required to have a perfect display effect, a high contrast, a rapid response, etc.; on the other hand, it is also required to be suitable for the applications in more occasions, for example, the readability in a low-temperature environment, making the liquid crystal display more suitable for outdoor use at a low temperature.

The optical anisotropy of the composition is related to the contrast of the device. In order to maximize the contrast ratio of the liquid crystal display device, the optical anisotropy (Δn) of the liquid crystal composition and the thickness (d) of the liquid crystal layer can be adjusted. The appropriate product value depends on the types of operating mode. Typically, the Δn·d of the TN mode liquid crystal display is about 0.40, and the Δn·d of the IPS mode liquid crystal display is about 0.35.

The relationship between transmittance and Δn·d is given as follows:

$$T = {Sin}^{2} 2 β \cdot {Sin}^{2} \frac{π}{λ} \cdot Δ n \cdot d$$

(T represents the transmittance).

When the retardation (Δn·d) is increased, the transmittance of the liquid crystal display is also increased. Thereby, the effect of increasing the transmittance can be achieved.

The liquid crystal composition of the present application achieves a significantly high Δn·d (up to approximately 480) without increasing the thickness of the liquid crystal layer, and can significantly improve the transmittance of the liquid crystal display. At the same time, the liquid crystal composition of the present invention has a smaller rotational viscosity and can satisfy the demand of rapid response. For example, when the driving voltage is 5.5 V and d is 3.7 μm, the response speed of the liquid crystal display is <8 ms.

The relationship between the response time and the rotational viscosity is given as follows:

$${τ}_{d} ( Optic ) = 1.1 \frac{γ {d}^{2}}{{π}^{2} {K}_{22}}$$

(τ_{d} represents the response time)

It can be seen from the above formula that, in the case where the thickness of the liquid crystal display layer is substantially constant, lowering the rotational viscosity of the liquid crystal composition can reduce its response time, and enable the rapid response of the liquid crystal display.

### SUMMARY OF THE INVENTION

The object of the present invention is to provide a liquid crystal composition having a higher retardation amount, a higher transmittance, a larger optical anisotropy, a proper clearing point, a lower rotational viscosity and a good low-temperature storage stability, which is applicable to a liquid crystal display, and ensures that a liquid crystal display comprising the liquid crystal composition of the present invention is able to satisfy the requirement of high-speed response at different temperatures.

Another object of the present invention is to provide a liquid crystal composition which is applicable to a liquid crystal display of AM-TFT display mode, IPS display mode and the like.

In one aspect, the present invention provides a liquid crystal composition, characterized in that, the liquid crystal composition comprises:

one or more compounds of general Formula I

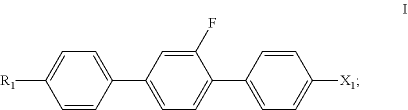

one or more compounds of general Formula II

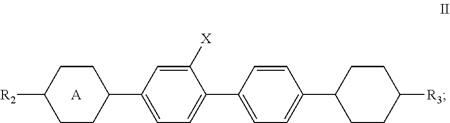

one or more compounds of general Formula III

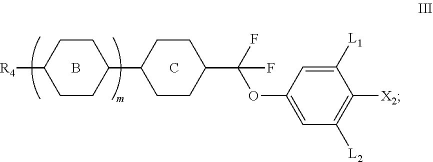

one or more compounds of general Formula IV

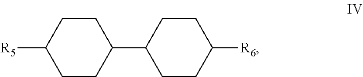

in which,

R₁, R₂, R₃, R₄, R₅ and R₆ each independently represents H, C₁-C₁₀ linear or branched alkyl or alkoxy, or C₂-C₁₀ alkenyl or alkenoxy;

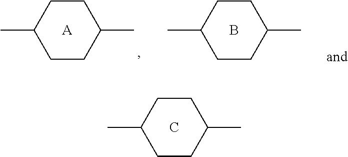

each independently represents

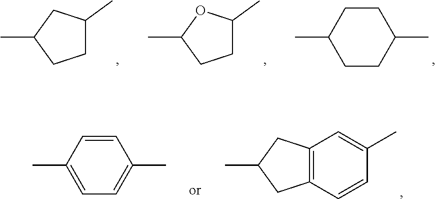

wherein, one or more —CH₂— on

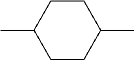

can be replaced by —O—, one or more H on

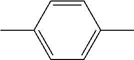

can be substituted by F;

X represents H or F;

X₁ represents F or —CH₂CH₂—CH═CF₂;

X₂ represents F, —CF₃, —OCF₃ or —OCF₂—CF═CF₂;

L₁ and L₂ are same or different, and each independently represents H or F;

m represents 1, 2 or 3;

wherein, when m does not represent 1,

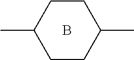

can be same or different.

In the embodiments of the present invention, preferably, R₁, R₂, R₃ and R₅ each independently represents C₁-C₇ linear or branched alkyl or alkoxy, or C₂-C₇ alkenyl or alkenoxy; more preferably, R₁, R₂, R₃ and R₅ each independently represents C₁-C₇ linear alkyl, or C₂-C₇ alkenyl; most preferably, R₁, R₂, R₃ and R₅ each independently represents C₁-C₇ linear alkyl. R₄ represents H, C₁-C₇ linear or branched alkyl or alkoxy, or C₂-C₇ alkenyl or alkenoxy; more preferably, R₄ represents H, C₁-C₇ linear alkyl. R₆ preferably represents C₁-C₇ linear or branched alkyl or alkoxy, or C₂-C₇ alkenyl or alkenoxy; more preferably, R₆ represents C₁-C₇ linear alkyl, or C₂-C₇ alkenyl.

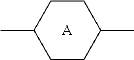

preferably represents

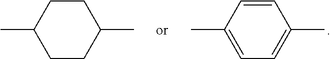

X₂ preferably represents F, —CF₃ or —OCF₃.

In the embodiments of the present invention, the compound of general Formula I provides 14-30% of the total weight of the liquid crystal composition; the compound of general Formula II provides 8-30% of the total weight of the liquid crystal composition; the compound of general Formula III provides 13-58% of the total weight of the liquid crystal composition; and the compound of general Formula IV provides 20-65% of the total weight of the liquid crystal composition.

In the embodiments of the present invention, preferably, the compound of general Formula I is one or more compounds selected form a group consisting of the following compounds:

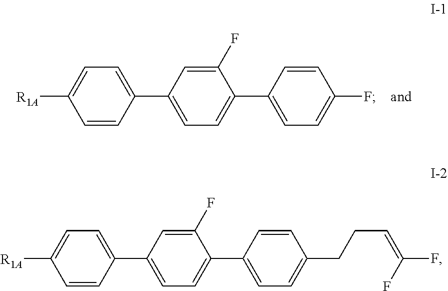

wherein,

R_{1A} represents C₁-C₇ linear or branched alkyl or alkoxy.

In the embodiments of the present invention, R_{1A} represents C₁-C₅ linear alkyl.

In the embodiments of the present invention, preferably, the compound of general Formula I-1 is one or more compounds selected from a group consisting of the following compounds:

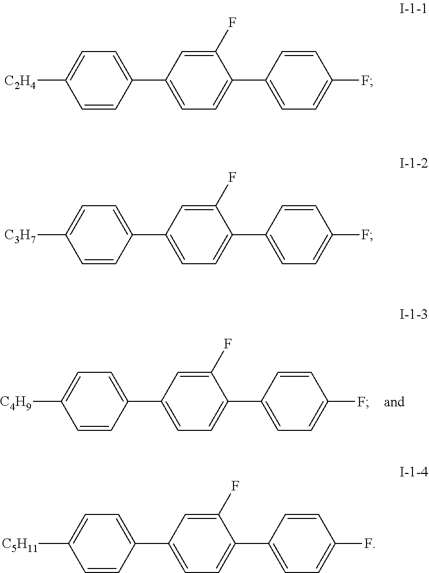

In the embodiments of the present invention, preferably, the compound of general Formula I-2 is one or more compounds selected from a group consisting of the following compounds:

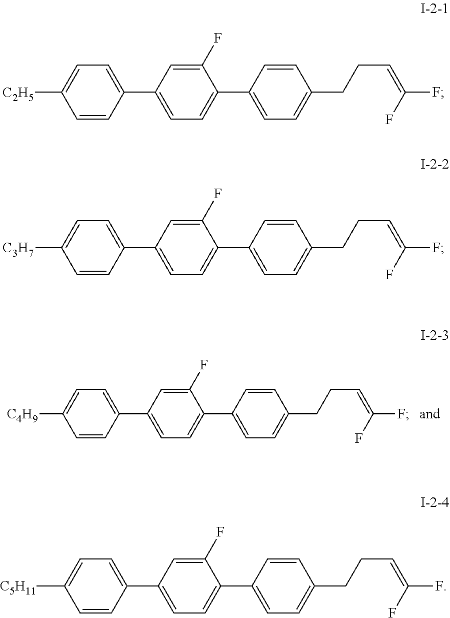

In the embodiments of the present invention, preferably, the compound of general Formula II is one or more compounds selected form a group consisting of the following compounds:

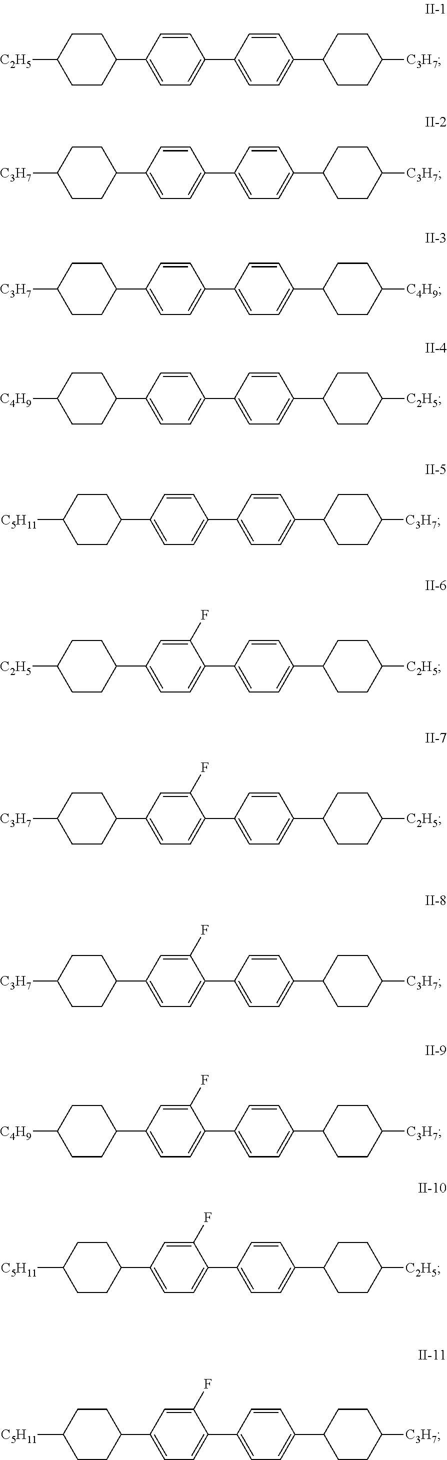

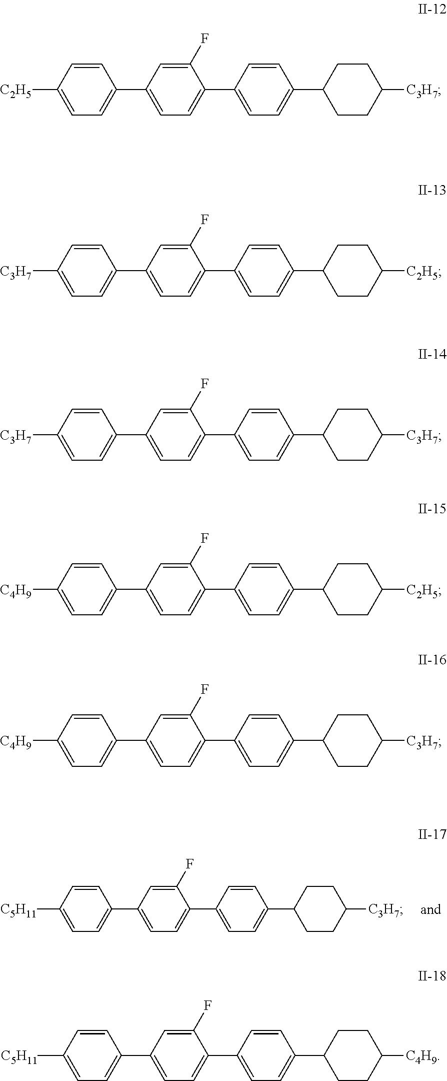

It is particularly preferred that, the compound of general Formula II is selected from a group consisting of the following compounds:

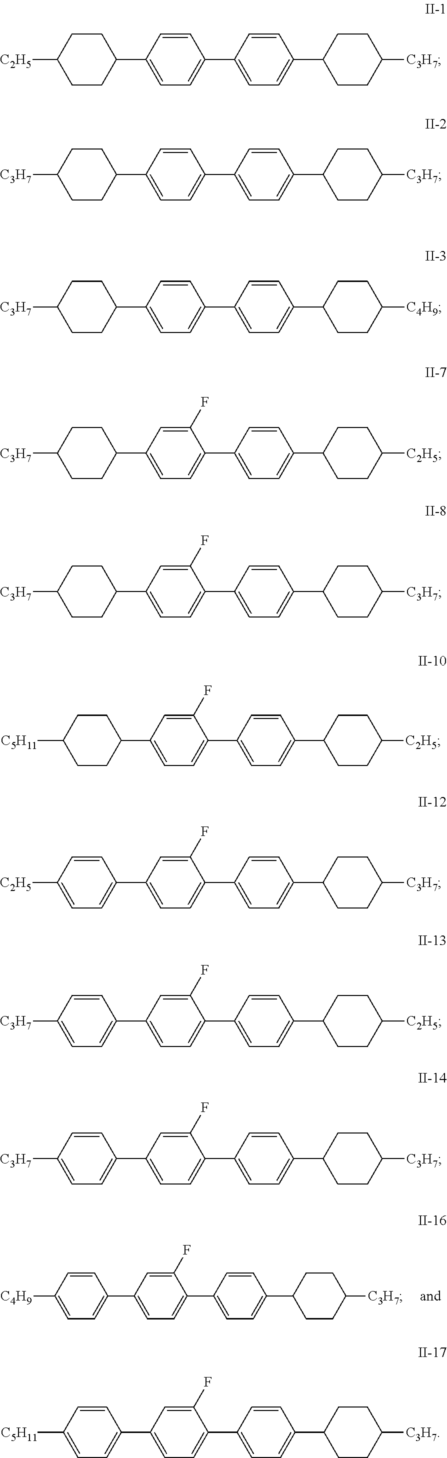

In the embodiments of the present invention, preferably, the compound of general Formula III is one or more compounds selected from a group consisting of the following compounds:

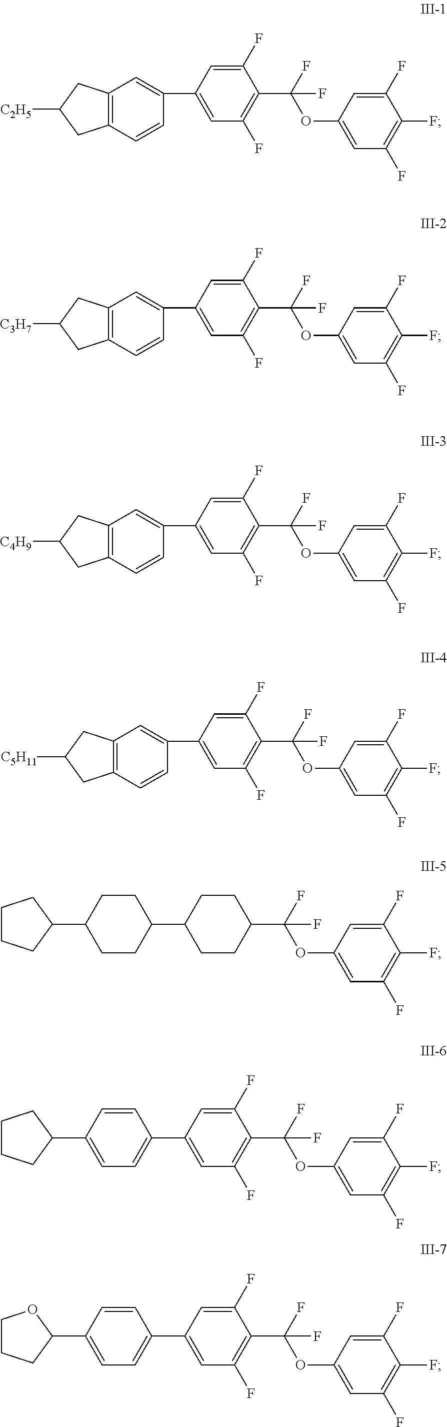

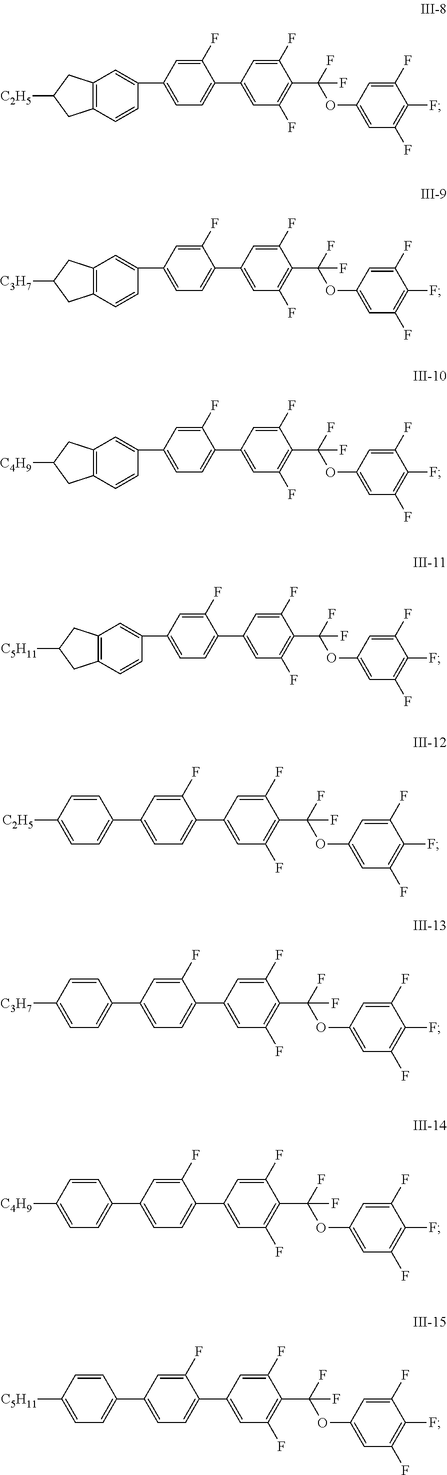

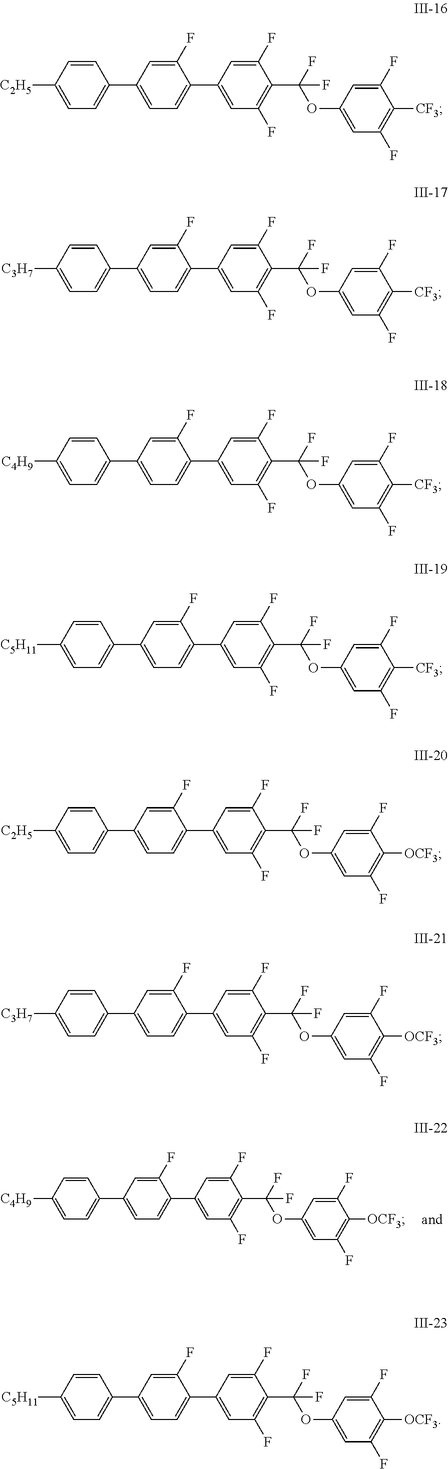

It is particularly preferred that, the compound of general Formula III is selected from a group consisting of the following compounds:

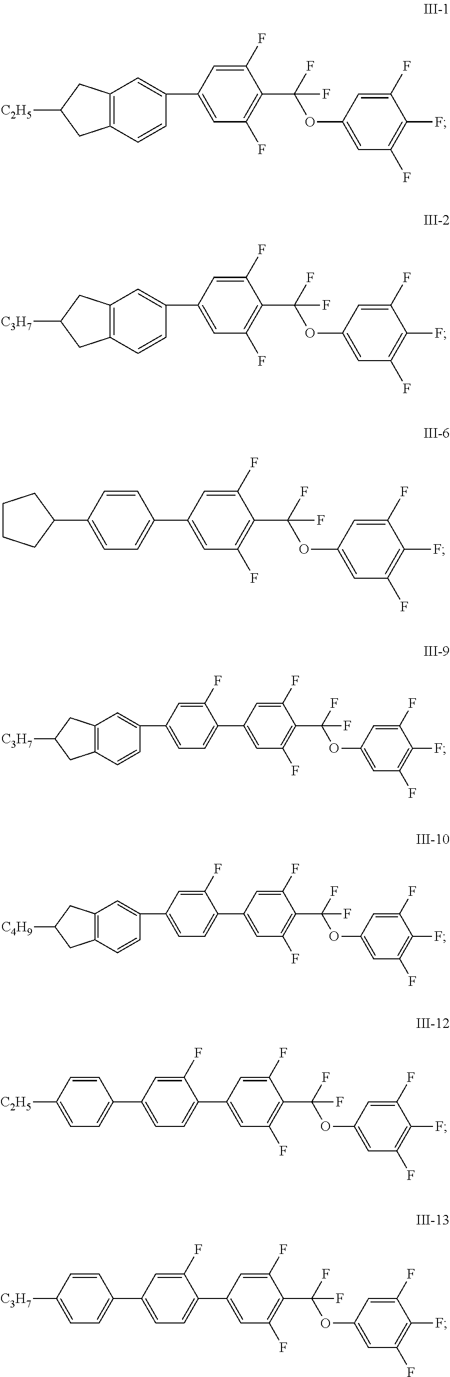

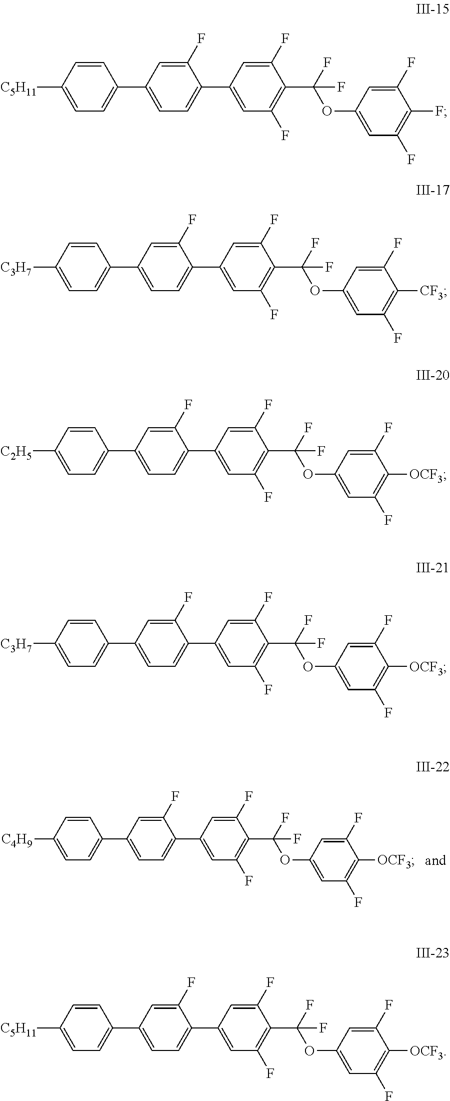

In the embodiments of the present invention, preferably, the compound of general Formula IV is one or more compounds selected from a group consisting of the following compounds:

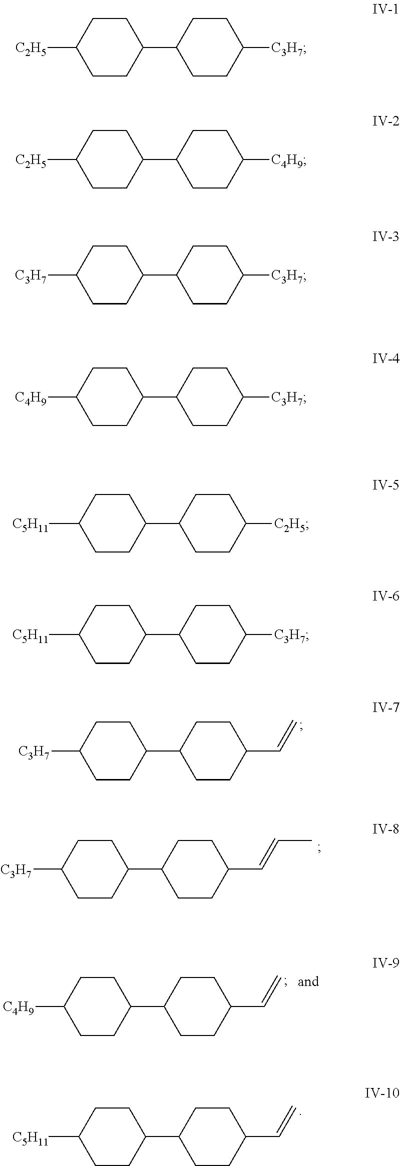

It is particularly preferred that, the compound of general Formula IV is selected from a group consisting of the following compounds:

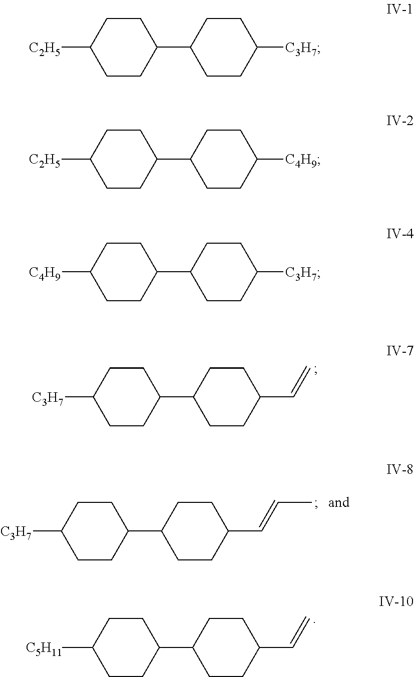

In the embodiments of the present invention, the liquid crystal composition may further comprise one or more compounds of general formula V:

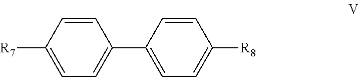

in which,

R₇ and R₈ are same or different, and each independently represents C₁-C₁₀ linear or branched alkyl or alkoxy, or C₂-C₁₀ alkenyl or alkenoxy.

In the embodiments of the present invention, preferably, the compound of general Formula V is one or more compounds selected from a group consisting of the following compounds:

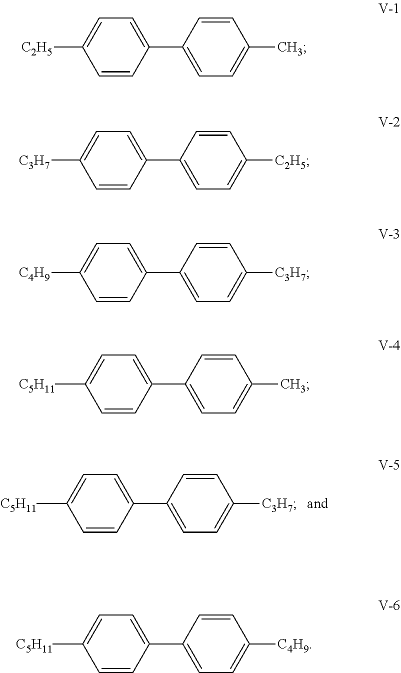

In the embodiments of the present invention, the compound of general Formula V provides 0-15% of the total weight of the liquid crystal composition; preferably, the compound of general Formula V provides 0-10% of the total weight of the liquid crystal composition; particularly preferably, the compound of general Formula V provides 1-10% of the total weight of the liquid crystal composition.

In the embodiments of the present invention, preferably, the compound of general Formula I provides 14-25% of the total weight of the liquid crystal composition; the compound of general Formula II provides 8-20% of the total weight of the liquid crystal composition; the compound of general Formula III provides 14.5-35% of the total weight of the liquid crystal composition; and the compound of general Formula IV provides 35-60% of the total weight of the liquid crystal composition.

More preferably, the compound of general Formula I provides 14-20% of the total weight of the liquid crystal composition; the compound of general Formula II provides 8.5-16% of the total weight of the liquid crystal composition; the compound of general Formula III provides 14.5-20% of the total weight of the liquid crystal composition; and the compound of general Formula IV provides 45-55% of the total weight of the liquid crystal composition

When the liquid crystal composition comprises compounds of general Formula I, general Formula II and general Formula III, the liquid crystal composition may have a higher retardation amount, a higher transmittance, a larger optical anisotropy, and a suitably high clearing point, and the addition of compounds of general Formula IV and general Formula V may ensure that the liquid crystal composition maintains a lower rotational viscosity and a good low-temperature storage stability.

Another aspect of the present invention is to provide a liquid crystal composition, which further comprises one or more additives known to those skilled in the art and described in the literatures. For example, 0-15% of polychromatic dye and/or chiral dopant can be added.

Dopants which can be preferably added to the mixture according to the present invention are shown below.

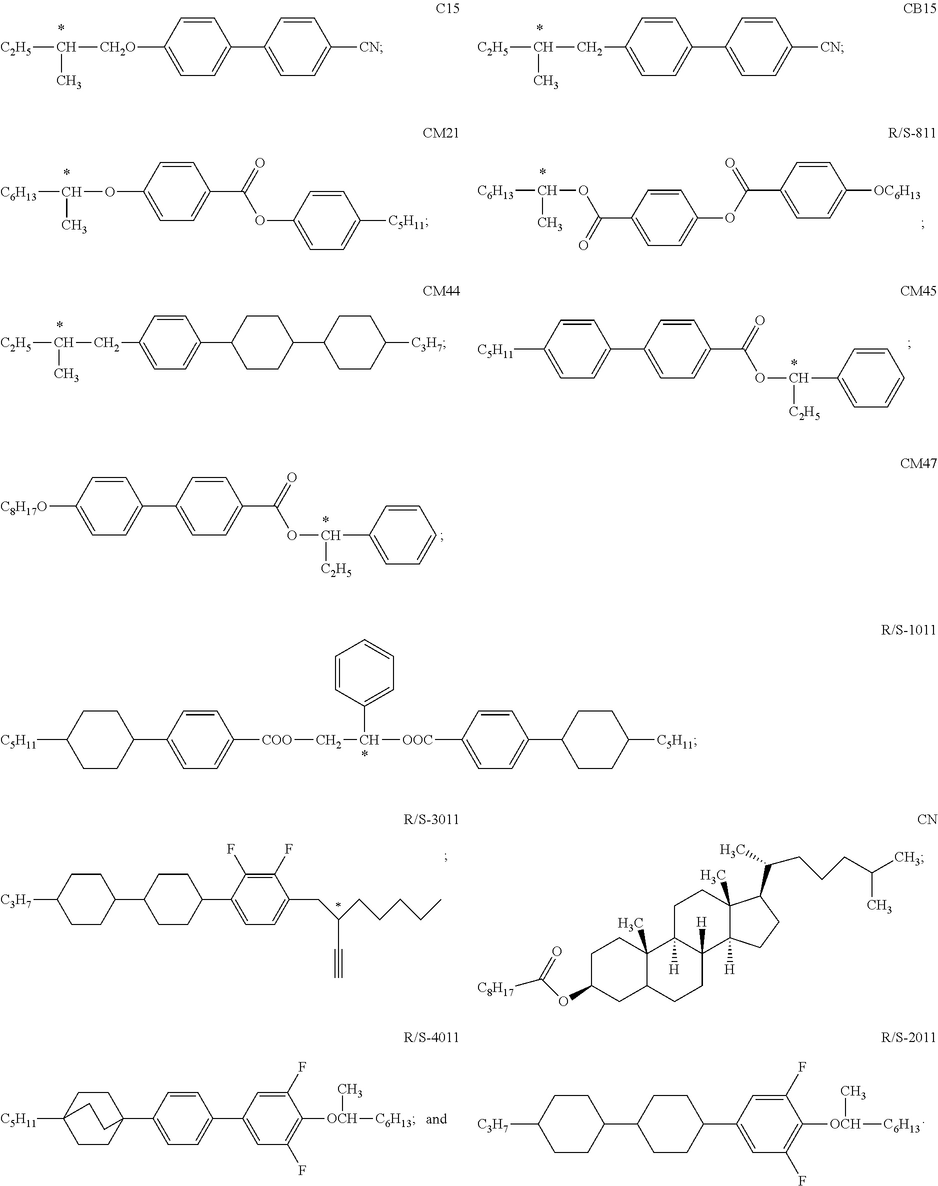

In the embodiments of the present invention, preferably, the dopant provides 0-5% of the total weight of the liquid crystal composition; more preferably, the dopant provides 0-1% of the total weight of the liquid crystal composition; particularly preferably, the dopant provides 0.001-0.8% of the total weight of the liquid crystal composition.

Stabilizers which can be added, for example, to the mixture according to the present invention are mentioned below.

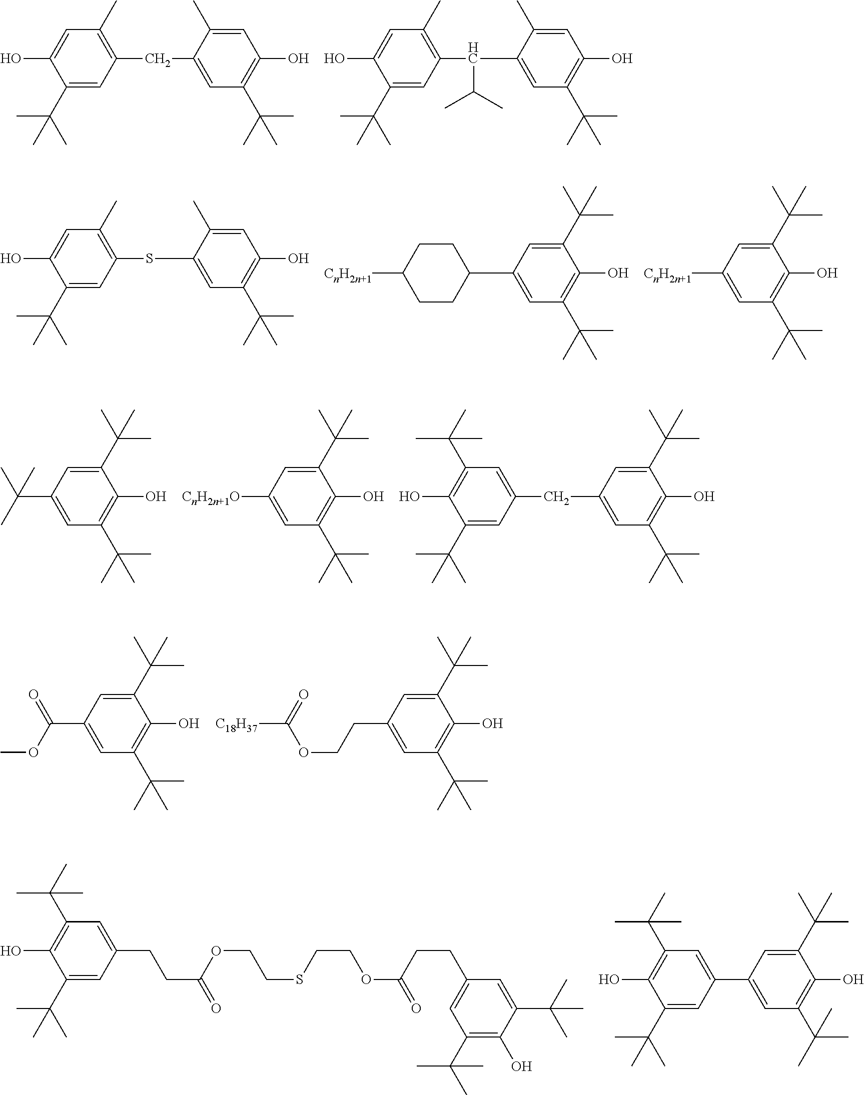

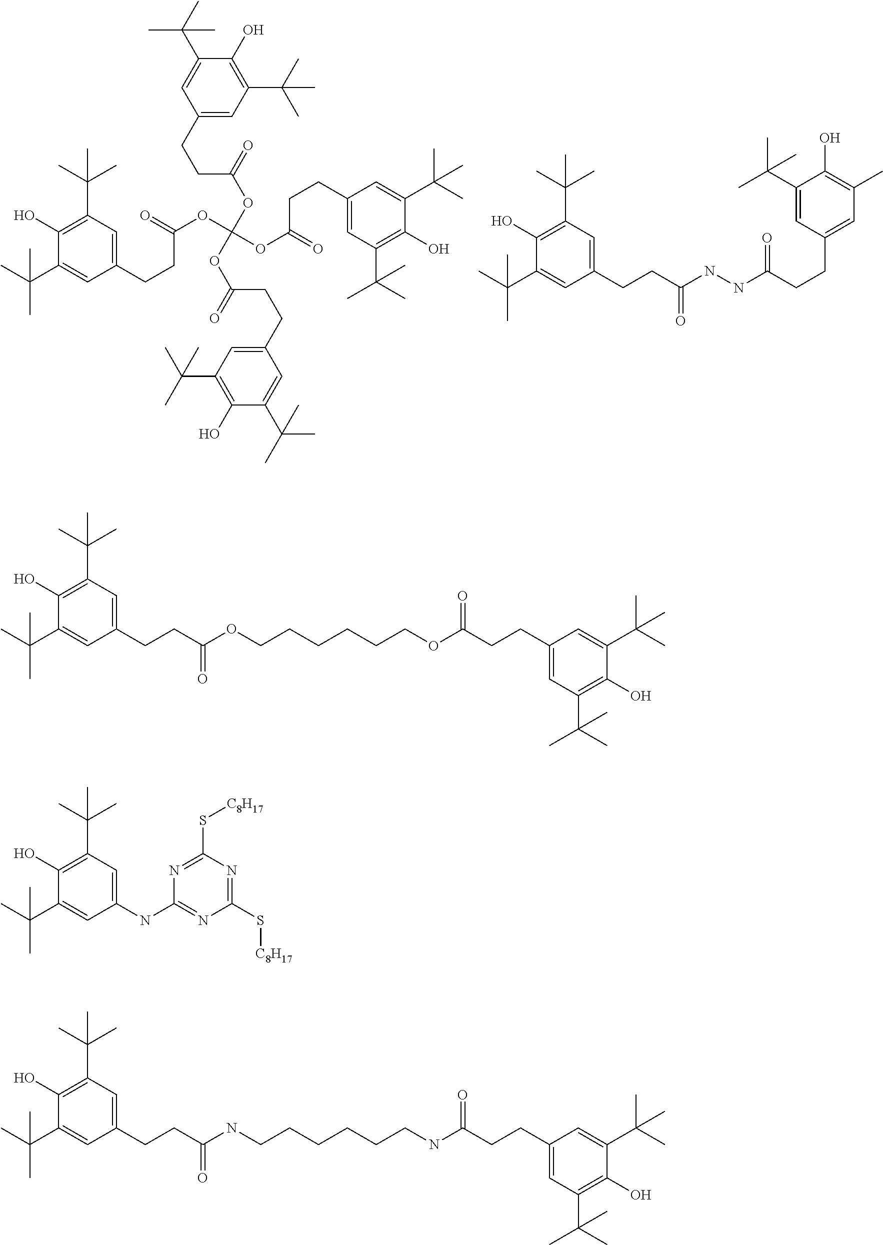

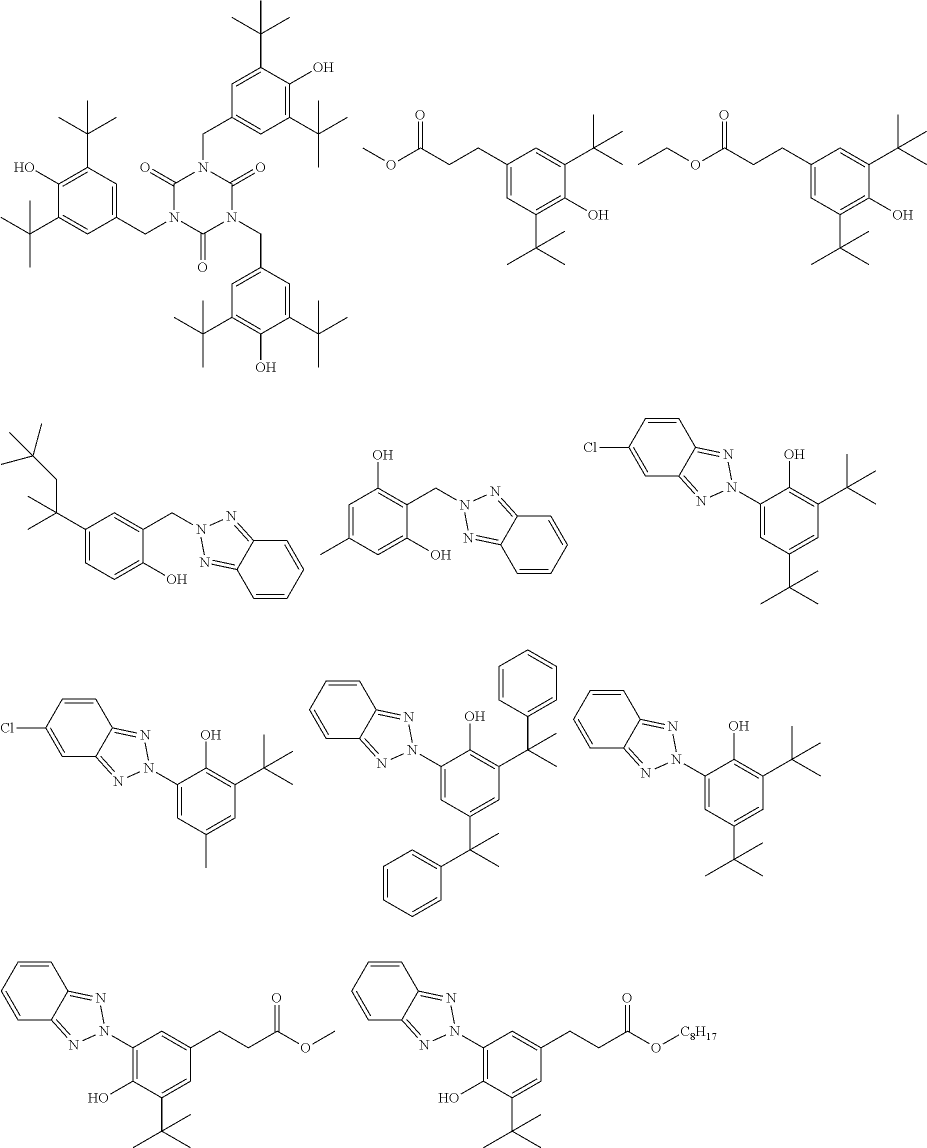

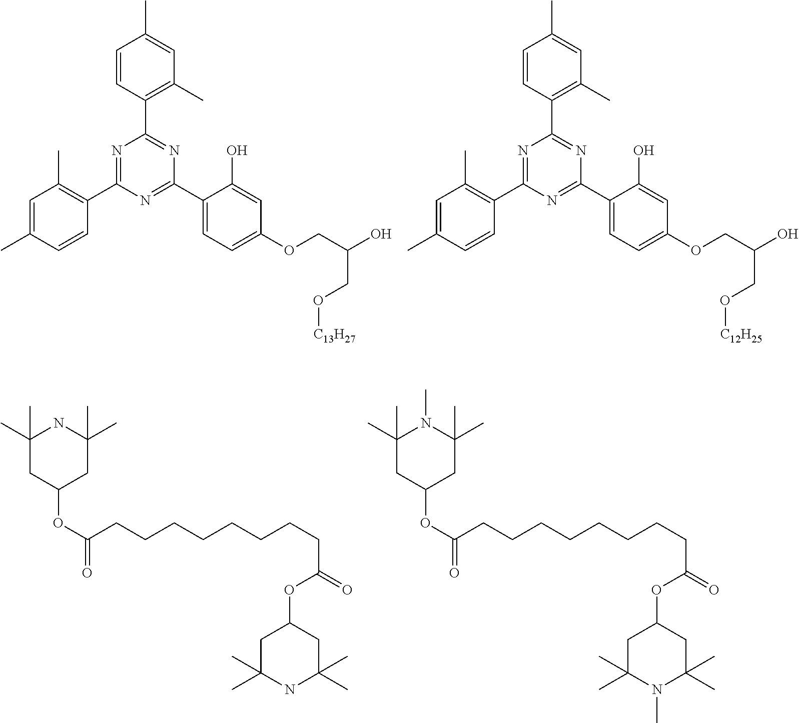

Preferably, the stabilizer is selected from a group consisting of stabilizers as shown below.

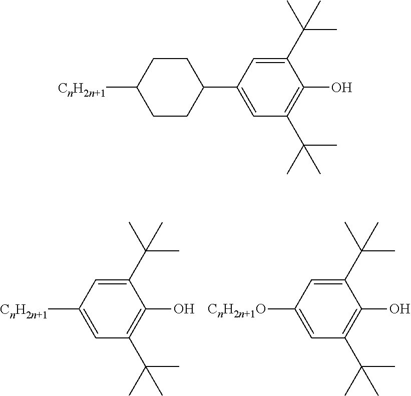

In the embodiments of the present invention, preferably, the stabilizer provides 0-5% of the total weight of the liquid crystal composition; more preferably, the stabilizer provides 0-1% of the total weight of the liquid crystal composition; as a particularly preferred embodiment, the stabilizer provides 0.001-0.1% of the total weight of the liquid crystal composition.

In still another aspect, the present invention provides a liquid crystal display device comprising the liquid crystal composition of the present invention.

The liquid crystal composition of the present invention has a higher retardation amount, a higher transmittance, a larger optical anisotropy, a proper clearing point, a lower rotational viscosity and a good low-temperature storage stability, and is applicable to a liquid crystal display device. The liquid crystal display device comprising the liquid crystal composition of the present invention can satisfy the requirement of rapid response at different temperatures.

Unless specifically indicated, in the present invention, the ratio is weight ratio, the temperature is in degree Celsius, and the cell gap selected for the test for response time data is 3.7 μm.

### DETAILED EMBODIMENTS

The present invention will be illustrated by combining the detailed embodiments below. It should be noted that, the following examples are exemplary embodiments of the present invention, which are only used to illustrate the present invention, not to limit it. Other combinations and various modifications within the conception of the present invention are possible without departing from the subject matter and scope of the present invention.

For the convenience of the expression, the group structures of the liquid crystal compositions in the following Examples are represented by the codes listed in Table 1:

TABLE 1
Codes of the group structures of the liquid crystal compounds

| Unit structure of group | Code | Name of the group |
|---|---|---|
| 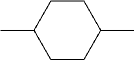 | C | 1,4-cyclohexylidene |
| 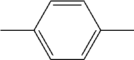 | P | 1,4-phenylene |
| 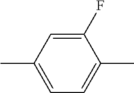 | G | 2-fluoro-1,4-phenylene |
| 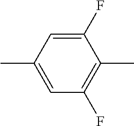 | U | 2,5-difluoro-1,4-phenylene |
| 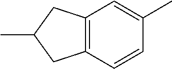 | I | indan-2,5-diyl |
| —F | F | fluorine substituent |
| —CH═CH— | V | alkenyl |
| —CF₂O— | Q | difluoro ether group |
| —OCF₃ | OCF3 | trifluoromethoxy |
| —CF₃ | CF3 | trifluoromethyl |
| —CH═CF₂ | V(2F) | 1,1-difluorovinyl |
| —C₂H₄— | 2 | ethylene |
| —CₙH₂ₙ₊₁ or —CₘH₂ₘ₊₁ | n or m | alkyl |

Take the compound with the following structural formula as an example:

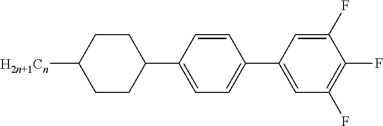

Represented by the codes listed in Table 1, this structural formula can be expressed as nCPUF, in which, n in the code represents the number of the carbon atoms of the alkyl group on the left, for example, n is “3”, meaning that the alkyl is —C₃H₇; C in the code represents “cyclohexyl”.

The abbreviated codes of the test items in the following Examples are represented as follows:

Cp (□): clearing point (nematic-isotropy phases transition temperature)

Δn: optical anisotropy (589 nm, 25 □)

Δn·d: retardation amount (mm)

d: thickness of the liquid crystal layer (μm)

τ: response time (ms)

γ1: rotational viscosity (mPa*s, at 25 □)

t-_{30□}: low-temperature storage time (at −30 □)

wherein, the optical anisotropy is tested and obtained by using abbe refractometer under sodium lamp (589 nm) light source at 25 □.

The response time is tested by the tester DMS505 at 25 □; the test cell is the left-handed TN type, the cell gap is 3.7 μm, and the driving voltage is 5.5 V.

γ1 is tested and obtained by the TOY06254 type liquid crystal physical property evaluation system; the test temperature is 25 □, and the test voltage is 90 V.

### Comparative Example 1

The liquid crystal composition of Comparative Example 1 is prepared according to each compound and weight percentage listed in Table 2 and then tested for performance by filling the same between two substrates of a liquid crystal display device. The test data is shown in the Table below:

TABLE 2
Formulation of the liquid crystal composition and its test performances

| Code of | Compound | | Test results for the | |
|---|---|---|---|---|
| component | No. | Content, % | performance parameters | |
| 3CGPC3 | II-8 | 4 | Cp | 95 |
| 3CPUF | | 18 | Δn | 0.116 |
| 5CPUF | | 9 | Δn · d | 0.40 |
| 3CCP1 | | 3 | d | 3.5 |
| 3CCV | IV-7 | 35 | τ | 8 |
| 3CCV1 | IV-8 | 10 | γ1 | 73 |
| 2PGPC3 | II-12 | 4 | t_{-30□} | ≥7 d |
| 3PGPC2 | II-13 | 5 | | |
| 3PGPF | I-1-2 | 2 | | |
| 5PGPF | I-1-4 | 3 | | |
| 3PGUQPOCF3 | III-21 | 7 | | |

| | |
|---|---|
| Total | 100 |

### Example 1

The liquid crystal composition of Example 1 is prepared according to each compound and weight percentage listed in Table 3 and then tested for performance by filling the same between two substrates of a liquid crystal display device. The test data is shown in the Table below:

TABLE 3
Formulation of the liquid crystal composition and its test performances

| Code of | Compound | | Test results for the | |
|---|---|---|---|---|
| component | No. | Content, % | performance parameters | |
| 3CPPC3 | II-3 | 2.5 | Cp | 90 |
| 3CGPC3 | II-8 | 2 | Δn | 0.129 |
| 3CC2 | IV-1 | 6 | Δn · d | 0.477 |
| 3CCV | IV-7 | 28 | d | 3.7 |
| 4CC3 | IV-4 | 8 | τ | 7.6 |
| 3CCV1 | IV-8 | 7 | γ1 | 69 |
| 2PGPC3 | II-12 | 5 | t_{-30□} | ≥7 d |
| 3PGPC2 | II-13 | 6 | | |
| 2PGP2V(2F) | I-2-1 | 7 | | |
| 3PGP2V(2F) | I-2-2 | 6 | | |
| 5PGPF | I-1-4 | 7 | | |
| 2IUQUF | III-1 | 4 | | |
| 3IUQUF | III-2 | 7.5 | | |
| 3PGUQUF | III-13 | 4 | | |

| | |
|---|---|
| Total | 100 |

### Example 2

The liquid crystal composition of Example 2 is prepared according to each compound and weight percentage listed in Table 4 and then tested for performance by filling the same between two substrates of a liquid crystal display device. The test data is shown in the Table below:

TABLE 4
Formulation of the liquid crystal composition and its test performances

| Code of | Compound | | Test results for the | |
|---|---|---|---|---|
| component | No. | Content, % | performance parameters | |
| 3CPPC3 | II-3 | 2.5 | Cp | 92 |
| 3CGPC3 | II-8 | 2 | Δn | 0.131 |
| 3CCV | IV-7 | 43 | Δn · d | 0.484 |
| 3CCV1 | IV-8 | 10 | d | 3.7 |
| 2PGPC3 | II-12 | 3.5 | τ | 7.5 |
| 3PGPC2 | II-13 | 4 | γ1 | 72 |
| 3PGPF | I-1-2 | 7 | t_{-30□} | ≥7 d |
| 4PGPF | I-1-3 | 6 | | |
| 5PGPF | I-1-4 | 7 | | |
| 3IUQUF | III-2 | 5 | | |
| 3PGUQUF | III-13 | 4 | | |
| 2PGUQPOCF3 | III-20 | 3 | | |
| 3PGUQPOCF3 | III-21 | 3 | | |

| | |
|---|---|
| Total | 100 |

### Example 3

The liquid crystal composition of Example 3 is prepared according to each compound and weight percentage listed in Table 5 and then tested for performance by filling the same between two substrates of a liquid crystal display device. The test data is shown in the Table below:

TABLE 5
Formulation of the liquid crystal composition and its test performances

| Code of | Compound | | Test results for the | |
|---|---|---|---|---|
| component | No. | Content, % | performance parameters | |
| 3CPPC3 | II-3 | 2.5 | Cp | 90 |
| 3CGPC3 | II-8 | 2.5 | Δn | 0.131 |
| 5PP1 | V-4 | 9 | Δn · d | 0.484 |
| 3CC2 | IV-1 | 10 | d | 3.7 |
| 3CCV | IV-7 | 29 | τ | 7.3 |
| 3CCV1 | IV-8 | 7 | γ1 | 71 |
| 2PGPC3 | II-12 | 5 | t_{-30□} | ≥7 d |
| 3PGPC2 | II-13 | 6 | | |
| 3PGPF | I-1-2 | 5 | | |
| 4PGPF | I-1-3 | 4 | | |
| 3PGP2V(2F) | I-2-2 | 5 | | |
| 3IUQUF | III-2 | 5 | | |
| 3PGUQUF | III-13 | 4 | | |
| 2PGUQPOCF3 | III-20 | 3 | | |
| 3PGUQPOCF3 | III-21 | 3 | | |

| | |
|---|---|
| Total | 100 |

### Example 4

The liquid crystal composition of Example 4 is prepared according to each compound and weight percentage listed in Table 6 and then tested for performance by filling the same between two substrates of a liquid crystal display device. The test data is shown in the Table below:

TABLE 6
Formulation of the liquid crystal composition and its test performances

| Code of | Compound | | Test results for the | |
|---|---|---|---|---|
| component | No. | Content, % | performance parameters | |
| 3CPPC3 | II-3 | 2.5 | Cp | 92 |
| 3CGPC3 | II-8 | 2 | Δn | 0.130 |
| 5PP1 | V-4 | 4.5 | Δn · d | 0.481 |
| 3CCV | IV-7 | 42 | d | 3.7 |
| 3CCV1 | IV-8 | 9 | τ | 7.2 |
| 2PGPC3 | II-12 | 2.5 | γ1 | 71 |
| 3PGPC2 | II-13 | 3 | t_{-30□} | ≥7 d |
| 3PGPF | I-1-2 | 7 | | |
| 4PGPF | I-1-3 | 6 | | |
| 5PGPF | I-1-4 | 7 | | |
| 3PGUQUF | III-13 | 3 | | |
| 5PGUQUF | III-15 | 3 | | |
| 2PGUQPOCF3 | III-20 | 3 | | |
| 3PGUQPOCF3 | III-21 | 3 | | |
| 4PGUQPOCF3 | III-22 | 2.5 | | |

| | |
|---|---|
| Total | 100 |

### Example 5

The liquid crystal composition of Example 5 is prepared according to each compound and weight percentage listed in Table 7 and then tested for performance by filling the same between two substrates of a liquid crystal display device. The test data is shown in the Table below:

TABLE 7
Formulation of the liquid crystal composition and the its performances

| Code of | Compound | | Test results for the | |
|---|---|---|---|---|
| component | No. | Content, % | performance parameters | |
| 3CPPC3 | II-3 | 3 | Cp | 94 |
| 3CGPC3 | II-8 | 3 | Δn | 0.133 |
| 5PP1 | V-4 | 1.5 | Δn · d | 0.478 |
| 3CCV | IV-7 | 41 | d | 3.6 |
| 4CC3 | IV-4 | 9.5 | τ | 7.2 |
| 2PGPC3 | II-12 | 2.5 | γ1 | 73 |
| 3PGPC2 | II-13 | 2 | t_{-30□} | ≥7 d |
| 3PGPF | I-1-2 | 7 | | |
| 4PGPF | I-1-3 | 6 | | |
| 4PGP2V(2F) | I-2-3 | 7 | | |
| 3PGUQUF | III-13 | 3.5 | | |
| 5PGUQUF | III-15 | 3.5 | | |
| 2PGUQPOCF3 | III-20 | 3 | | |
| 3PGUQPOCF3 | III-21 | 4 | | |
| 4PGUQPOCF3 | III-22 | 3.5 | | |

| | |
|---|---|
| Total | 100 |

### Example 6

The liquid crystal composition of Example 6 is prepared according to each compound and weight percentage listed in Table 8 and then tested for performance by filling the same between two substrates of a liquid crystal display device. The test data is shown in the Table below:

TABLE 8
Formulation of the liquid crystal composition and its test performances

| Code of | Compound | | Test results for the | |
|---|---|---|---|---|
| component | No. | Content, % | performance parameters | |
| 3CPPC3 | II-3 | 2.5 | Cp | 92 |
| 3CGPC3 | II-8 | 2 | Δn | 0.130 |
| 5PP1 | V-4 | 3.5 | Δn · d | 0.481 |
| 3CCV | IV-7 | 41 | d | 3.7 |
| 3CCV1 | IV-8 | 9.5 | τ | 7 |
| 2PGPC3 | II-12 | 2 | γ1 | 70 |
| 3PGPC2 | II-13 | 2 | t_{-30□} | ≥7 d |
| 3PGPF | I-1-2 | 7 | | |
| 4PGPF | I-1-3 | 6 | | |
| 5PGPF | I-1-4 | 7 | | |
| 3PGUQUF | III-13 | 3.5 | | |
| 5PGUQUF | III-15 | 3.5 | | |
| 2PGUQPOCF3 | III-20 | 3 | | |
| 3PGUQPOCF3 | III-21 | 4 | | |
| 4PGUQPOCF3 | III-22 | 3.5 | | |

| | |
|---|---|
| Total | 100 |

As can be known from the test performance parameters of the liquid crystal compositions in Comparative Example 1 and Examples 1-6, the synergies between the components enable the liquid crystal composition of the present invention with a significantly higher retardation amount, a larger optical anisotropy value, a lower rotational viscosity, and a good low-temperature storage stability. Meanwhile, the liquid crystal composition comprising compounds of general Formulas I, II, III and IV, which is screened by a large number of experiments, has proper clearing point and good reliability, and is suitable for the liquid crystal display of AM-TFT display mode, IPS display mode, and the like. A large number of inventive experimental adjustments for the different ratios of the compounds of general Formulas I, II, III, IV ensure that the liquid crystal display comprising the liquid crystal composition of the present invention is capable of meeting the need for rapid response at different temperatures.

### INDUSTRIAL APPLICABILITY

The liquid crystal composition can be applied to the field of liquid crystal.

1. A liquid crystal composition comprising:
one or more compounds of general Formula I 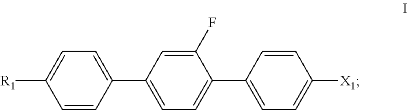
one or more compounds of general Formula II 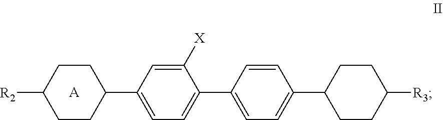
one or more compounds of general Formula III 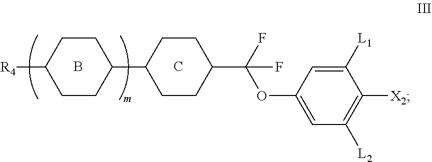
one or more compounds of general Formula IV 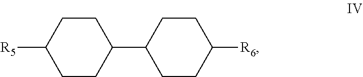
in which,
R₁, R₂, R₃, R₄, R₅ and R₆ each independently represents H, C₁-C₁₀ linear or branched alkyl or alkoxy, or C₂-C₁₀ alkenyl or alkenoxy; 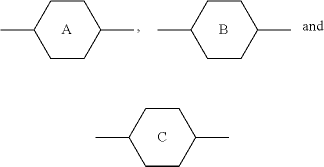
each independently represents 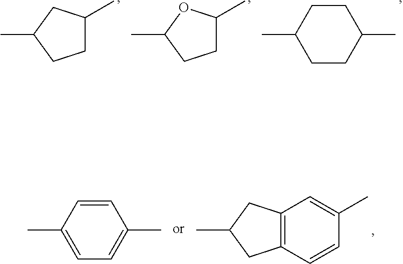
wherein, one or more —CH₂— on 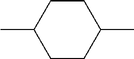
can be replaced by —O—, one or more H on 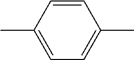
can be substituted by F;
X represents H or F;
X₁ represents F or —CH₂CH₂—CH═CF₂;
X₂ represents F, —CF₃, —OCF₃ or —OCF₂—CF═CF₂;
L₁ and L₂ are same or different, and each independently represents H or F;
m represents 1, 2 or 3; and
wherein, when m does not represent 1, 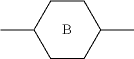
can be same or different.

2. The liquid crystal composition according to claim 1, wherein the compound of general Formula I provides 14-30% of the total weight of the liquid crystal composition; the compound of general Formula II provides 8-30% of the total weight of the liquid crystal composition; the compound of general Formula III provides 13-58% of the total weight of the liquid crystal composition; and the compound of general Formula IV provides 20-65% of the total weight of the liquid crystal composition.

3. The liquid crystal composition according to claim 1, wherein the compound of general Formula I is one or more compounds selected form a group consisting of the following compounds: 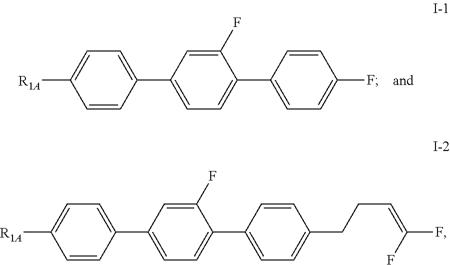
wherein,
R_{1A} represents C₁-C₇ linear or branched alkyl or alkoxy.

4. The liquid crystal composition according to claim 1, wherein the compound of general Formula II is one or more compounds selected form a group consisting of the following compounds:

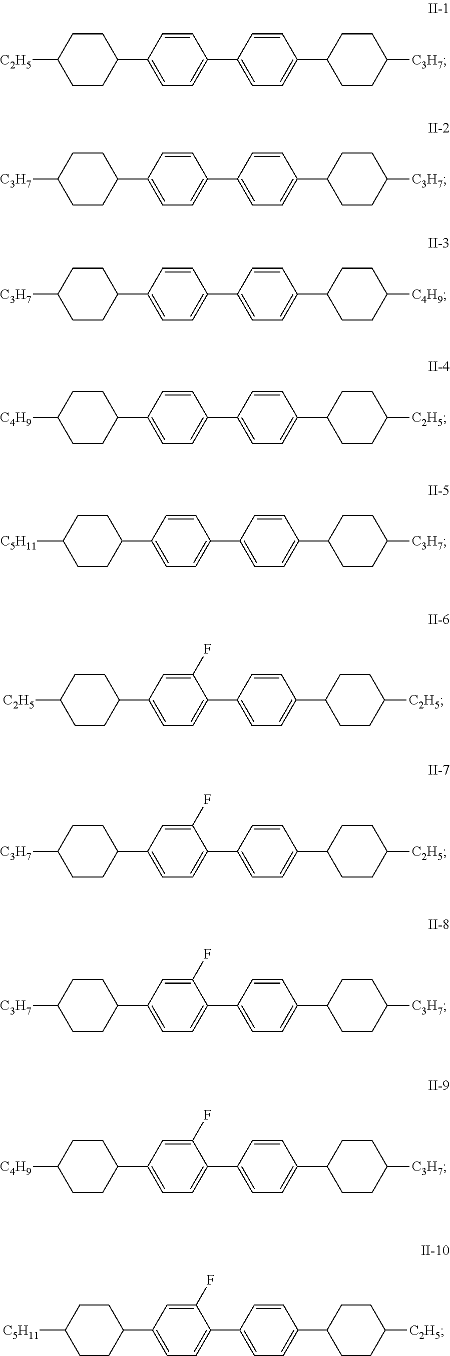

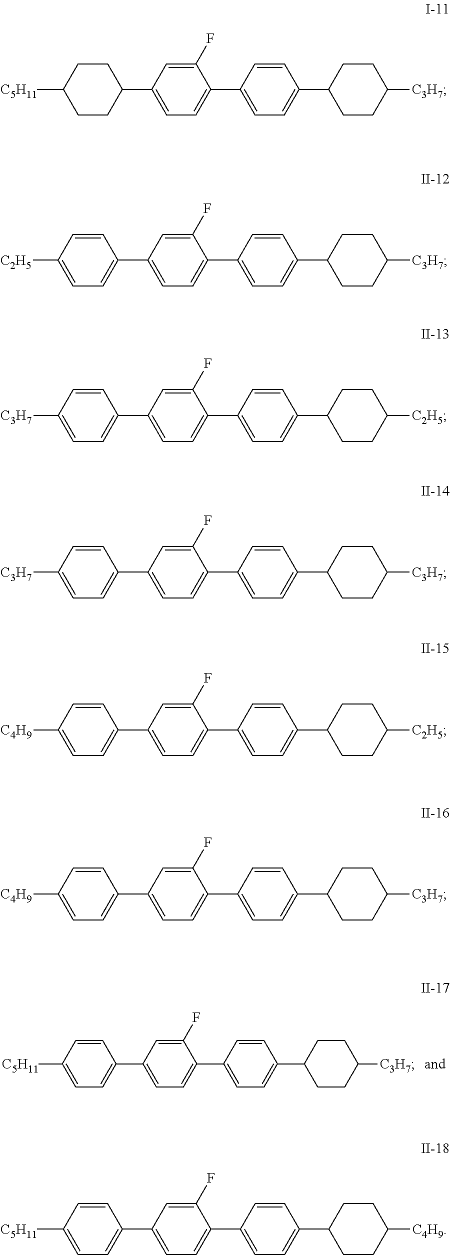

5. The liquid crystal composition according to claim 1, wherein the compound of general Formula III is one or more compounds selected from a group consisting of the following compounds:

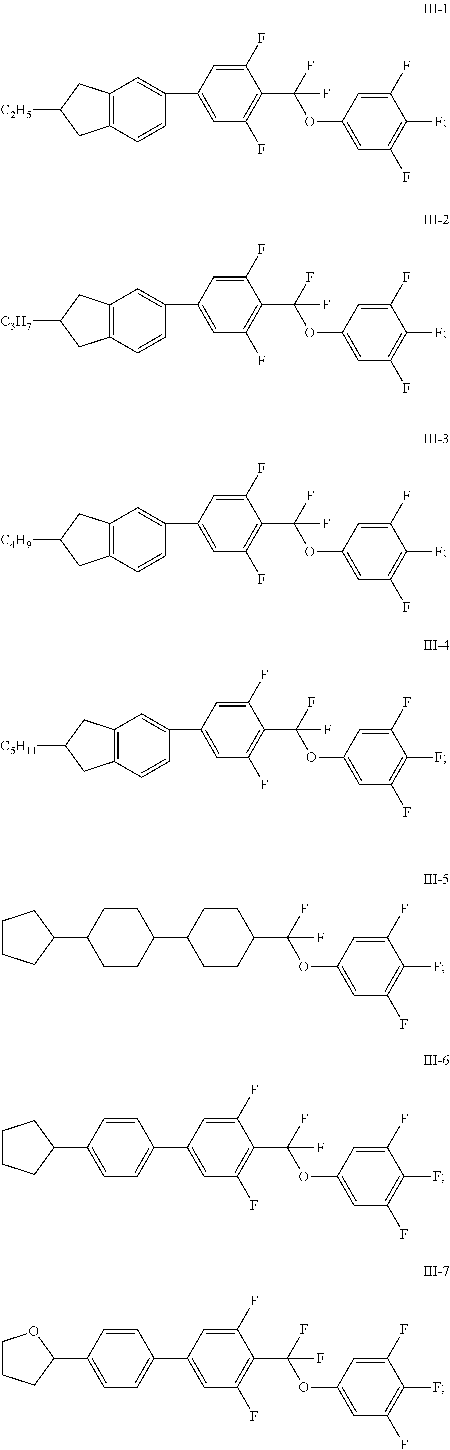

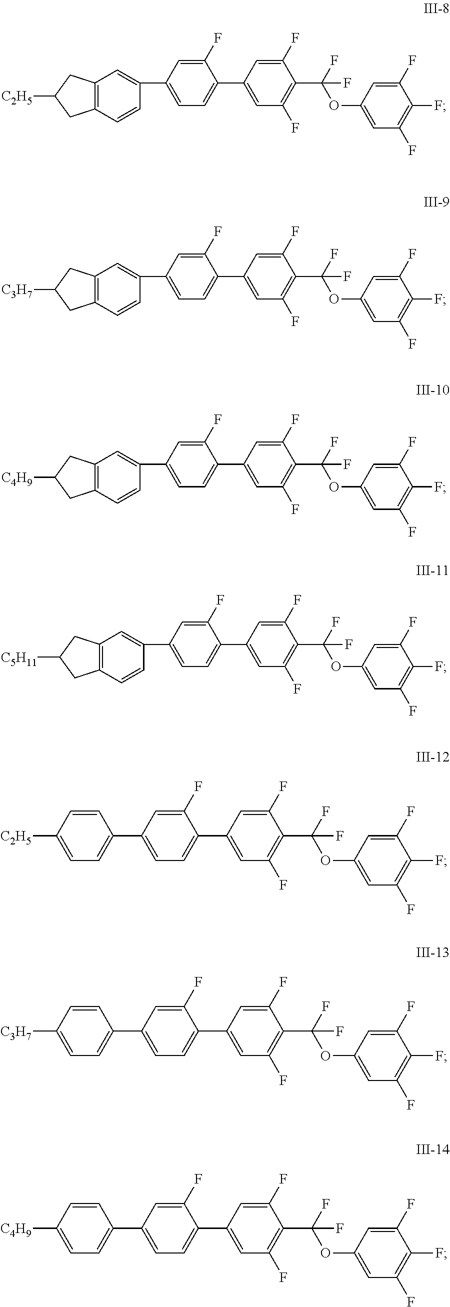

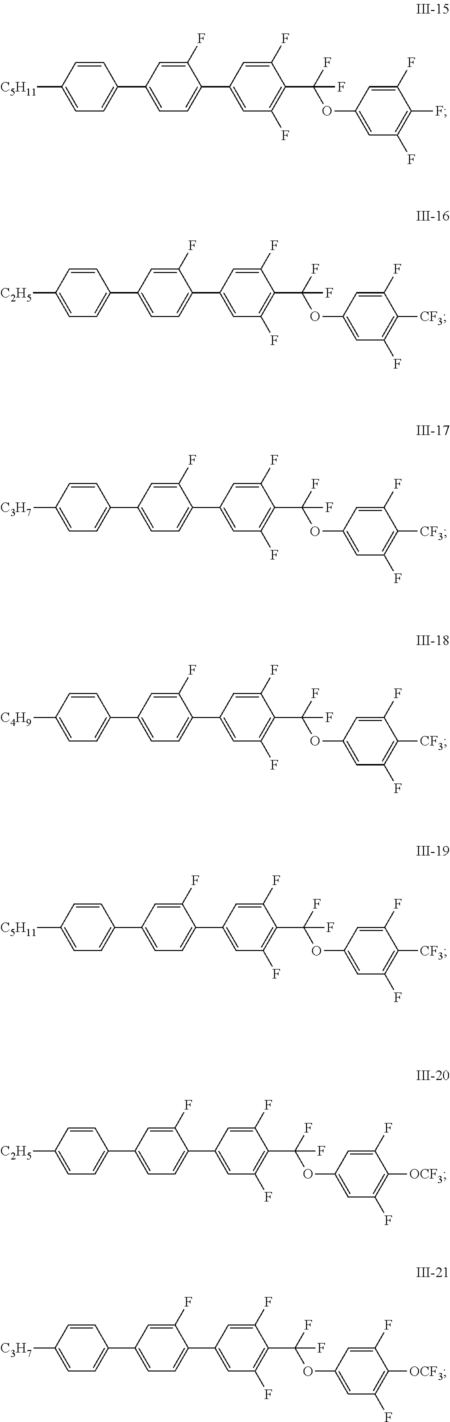

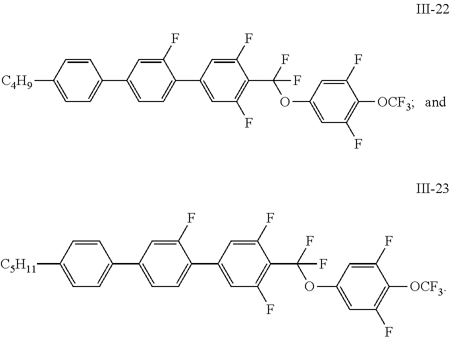

6. The liquid crystal composition according to claim 1, wherein the compound of general Formula IV is one or more compounds selected from a group consisting of the following compounds:

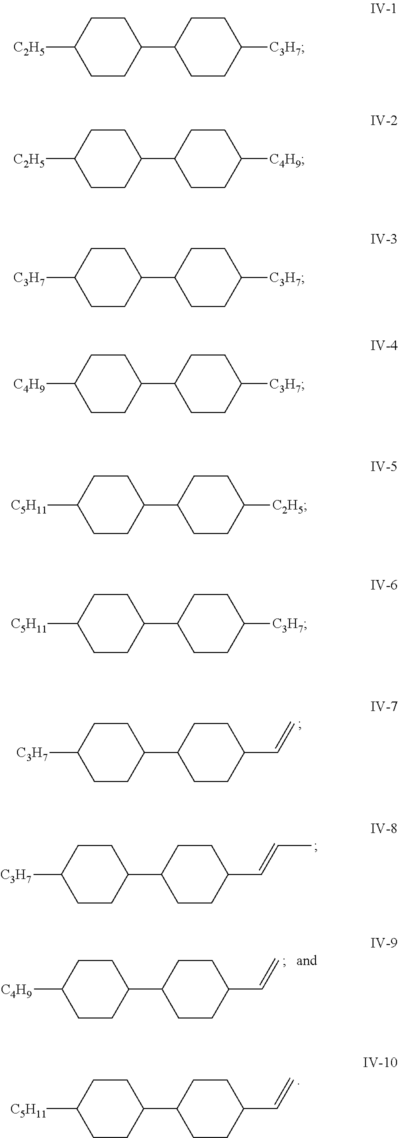

7. The liquid crystal composition according to claim 3, wherein the compound of general Formula I-1 is one or more compounds selected from a group consisting of the following compounds: 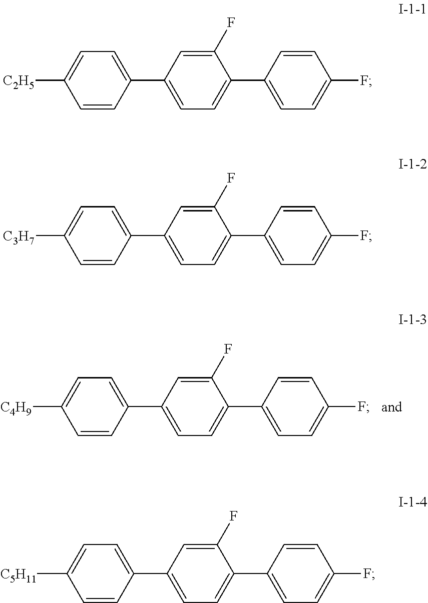
and
the compound of general Formula I-2 is one or more compounds selected from a group consisting of the following compounds:

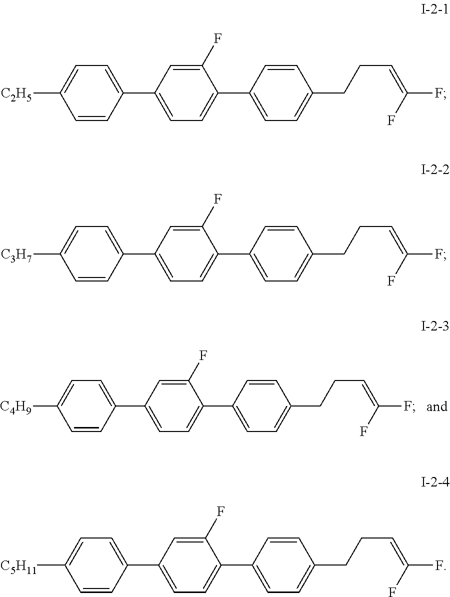

8. The liquid crystal composition according to claim 2, wherein the compound of general Formula I provides 14-25% of the total weight of the liquid crystal composition; the compound of general Formula II provides 8-20% of the total weight of the liquid crystal composition; the compound of general Formula III provides 14.5-35% of the total weight of the liquid crystal composition; and the compound of general Formula IV provides 35-60% of the total weight of the liquid crystal composition.

9. The liquid crystal composition according to claim 8, wherein the compound of general Formula I provides 14-20% of the total weight of the liquid crystal composition; the compound of general Formula II provides 8.5-16% of the total weight of the liquid crystal composition; the compound of general Formula III provides 14.5-20% of the total weight of the liquid crystal composition; and the compound of general Formula IV provides 45-55% of the total weight of the liquid crystal composition

10. The liquid crystal composition according to claim 1, wherein the liquid crystal composition further comprises one or more additives.

11. A liquid crystal display device comprising the liquid crystal composition of claim 1.
